(19) United States
(12) Patent Application Publication
(10) Pub. No.: US 2026/0352801 A1
(43) Pub. Date: Nov. 5, 2026

(54) Method and Apparatus of AMVP with Merge Mode for Video Coding

(71) Applicant: MEDIATEK INC., Hsinchu City (TW)

(72) Inventors: Chen-Yen LAI, Hsinchu City (TW); Tzu-Der CHUANG, Hsinchu City (TW); Ching-Yeh CHEN, Hsinchu City (TW)

(21) Appl. No.: 18/997,620

(22) PCT Filed: Jul. 17, 2023
(86) PCT No.: PCT/CN2023/107654

§ 371 Date: Jan. 22, 2025

Related U.S. Application Data
(60) Provisional application No. 63/369,672, filed on Jul. 28, 2022.

(51) Int. Cl. H04N 19/105; H04N 19/159; H04N 19/176

(52) U.S. Cl. CPC H04N 19/105; H04N 19/159; H04N 19/176

(57) ABSTRACT

Methods and apparatus of video coding using a simplified AMVP-merge mode or using AMVP-merge with BCW are disclosed. According to one method, a target AMVP candidate is determined from an AMVP candidate list. A merge candidate list is determined. Merge candidates in the merge candidate list are reordered according to MV costs associated with the merge candidates to form a reordered merge candidate list. A target merge candidate is determined from the reordered merge candidate list. A target AMVP-merge candidate is generated based on the target AMVP candidate and the target merge candidate. According to another method, a target weighting pair is determined from a weighting pair set comprising two or more weighting pairs. A target AMVP-merge candidate is generated as a weighted sum of the target AMVP candidate and the target merge candidate according to the target weighting pair.

### CROSS REFERENCE TO RELATED APPLICATIONS

The present invention claims priority to U.S. Provisional Patent Application, Ser. No. 63/369,672, filed on Jul. 28, 2022. The U.S. Provisional Patent Application is hereby incorporated by reference in its entirety.

### FIELD OF THE INVENTION

The present invention relates to video coding using motion estimation and motion compensation. In particular, the present invention relates to schemes to improve the performance of AMVP-Merge mode.

### BACKGROUND AND RELATED ART

Versatile video coding (VVC) is the latest international video coding standard developed by the Joint Video Experts Team (JVET) of the ITU-T Video Coding Experts Group (VCEG) and the ISO/IEC Moving Picture Experts Group (MPEG). The standard has been published as an ISO standard: ISO/IEC 23090-3: 2021, Information technology-Coded representation of immersive media—Part 3: Versatile video coding, published Feb. 2021. VVC is developed based on its predecessor HEVC (High Efficiency Video Coding) by adding more coding tools to improve coding efficiency and also to handle various types of video sources including 3-dimensional (3D) video signals.

FIG. 1A illustrates an exemplary adaptive Inter/Intra video coding system incorporating loop processing. For Intra Prediction, the prediction data is derived based on previously coded video data in the current picture. For Inter Prediction 112, Motion Estimation (ME) is performed at the encoder side and Motion Compensation (MC) is performed based on the result of ME to provide prediction data derived from other picture(s) and motion data. Switch 114 selects Intra Prediction 110 or Inter-Prediction 112 and the selected prediction data is supplied to Adder 116 to form prediction errors, also called residues. The prediction error is then processed by Transform (T) 118 followed by Quantization (Q) 120. The transformed and quantized residues are then coded by Entropy Encoder 122 to be included in a video bitstream corresponding to the compressed video data. The bitstream associated with the transform coefficients is then packed with side information such as motion and coding modes associated with Intra prediction and Inter prediction, and other information such as parameters associated with loop filters applied to underlying image area. The side information associated with Intra Prediction 110, Inter prediction 112 and in-loop filter 130, are provided to Entropy Encoder 122 as shown in FIG. 1A. When an Inter-prediction mode is used, a reference picture or pictures have to be reconstructed at the encoder end as well. Consequently, the transformed and quantized residues are processed by Inverse Quantization (IQ) 124 and Inverse Transformation (IT) 126 to recover the residues. The residues are then added back to prediction data 136 at Reconstruction (REC) 128 to reconstruct video data. The reconstructed video data may be stored in Reference Picture Buffer 134 and used for prediction of other frames.

As shown in FIG. 1A, incoming video data undergoes a series of processing in the encoding system. The reconstructed video data from REC 128 may be subject to various impairments due to a series of processing. Accordingly, in-loop filter 130 is often applied to the reconstructed video data before the reconstructed video data are stored in the Reference Picture Buffer 134 in order to improve video quality. For example, deblocking filter (DF), Sample Adaptive Offset (SAO) and Adaptive Loop Filter (ALF) may be used. The loop filter information may need to be incorporated in the bitstream so that a decoder can properly recover the required information. Therefore, loop filter information is also provided to Entropy Encoder 122 for incorporation into the bitstream. In FIG. 1A, Loop filter 130 is applied to the reconstructed video before the reconstructed samples are stored in the reference picture buffer 134. The system in FIG. 1A is intended to illustrate an exemplary structure of a typical video encoder. It may correspond to the High Efficiency Video Coding (HEVC) system, VP8, VP9, H.264 or VVC.

The decoder, as shown in FIG. 1B, can use similar or portion of the same functional blocks as the encoder except for Transform 118 and Quantization 120 since the decoder only needs Inverse Quantization 124 and Inverse Transform 126. Instead of Entropy Encoder 122, the decoder uses an Entropy Decoder 140 to decode the video bitstream into quantized transform coefficients and needed coding information (e.g. ILPF information, Intra prediction information and Inter prediction information). The Intra prediction 150 at the decoder side does not need to perform the mode search. Instead, the decoder only needs to generate Intra prediction according to Intra prediction information received from the Entropy Decoder 140. Furthermore, for Inter prediction, the decoder only needs to perform motion compensation (MC 152) according to Inter prediction information received from the Entropy Decoder 140 without the need for motion estimation.

According to VVC, an input picture is partitioned into non-overlapped square block regions referred as CTUs (Coding Tree Units), similar to HEVC. Each CTU can be partitioned into one or multiple smaller size coding units (CUs). The resulting CU partitions can be in square or rectangular shapes. Also, VVC divides a CTU into prediction units (PUs) as a unit to apply prediction process, such as Inter prediction, Intra prediction, etc.

The VVC standard incorporates various new coding tools to further improve the coding efficiency over the HEVC standard. Among various new coding tools, some coding tools relevant to the present invention are reviewed as follows.

### Bi-Prediction with CU-Level Weight (BCW)

In HEVC, the bi-prediction signal, P_{bi-pred} is generated by averaging two prediction signals, P₀ and P₁ obtained from two different reference pictures and/or using two different motion vectors. In VVC, the bi-prediction mode is extended beyond simple averaging to allow weighted average of the two prediction signals.

P_{bi-pred}=((8-w)*P₀+w*P₁+4)»3

Five weights are allowed in the weighted averaging bi-prediction, w∈{−2, 3, 4, 5, 10}. For each bi-predicted CU, the weight w is determined in one of two ways: 1) for a non-merge CU, the weight index is signalled after the motion vector difference; 2) for a merge CU, the weight index is inferred from neighbouring blocks based on the merge candidate index. BCW is only applied to CUs with 256 or more luma samples (i.e., CU width times CU height is greater than or equal to 256). For low-delay pictures, all 5 weights are used. For non-low-delay pictures, only 3 weights (w ∈{3,4,5}) are used. At the encoder, fast search algorithms are applied to find the weight index without significantly increasing the encoder complexity. These algorithms are summarized as follows. The details are disclosed in the VTM software and document JVET-L0646 (Yu-Chi Su, et. al., “CE4-related: Generalized bi-prediction improvements combined from JVET-L0197 and JVET-L0296”, Joint Video Experts Team (JVET) of ITU-T SG 16 WP 3 and ISO/IEC JTC 1/SC 29, 12th Meeting: Macao, CN, 3-12 Oct. 2018, Document: JVET-L0646).
When combined with AMVR, unequal weights are only conditionally checked for 1-pel and 4-pel motion vector precisions if the current picture is a low-delay picture.
When combined with affine, affine ME will be performed for unequal weights if and only if the affine mode is selected as the current best mode.
When the two reference pictures in bi-prediction are the same, unequal weights are only conditionally checked.
Unequal weights are not searched when certain conditions are met, depending on the POC (Picture Order Counts) distance between current picture and its reference pictures, the coding QP, and the temporal level.

The BCW weight index is coded using one context coded bin followed by bypass coded bins. The first context coded bin indicates if equal weight is used; and if unequal weight is used, additional bins are signalled using bypass coding to indicate which unequal weight is used.

Weighted prediction (WP) is a coding tool supported by the H.264/AVC and HEVC standards to efficiently code video content with fading. Support for WP is also added into the VVC standard. WP allows weighting parameters (weight and offset) to be signalled for each reference picture in each of the reference picture lists L0 and L1. Then, during motion compensation, the weight(s) and offset(s) of the corresponding reference picture(s) are applied. WP and BCW are designed for different types of video content. In order to avoid interactions between WP and BCW, which will complicate VVC decoder design, if a CU uses WP, then the BCW weight index is not signalled, and weight w is inferred to be 4 (i.e. equal weight is applied). For a merge CU, the weight index is inferred from neighbouring blocks based on the merge candidate index. This can be applied to both the normal merge mode and inherited affine merge mode. For the constructed affine merge mode, the affine motion information is constructed based on the motion information of up to 3 blocks. The BCW index for a CU using the constructed affine merge mode is simply set equal to the BCW index of the first control point MV.

In VVC, CIIP and BCW cannot be jointly applied for a CU. When a CU is coded with CIIP mode, the BCW index of the current CU is set to 2, (i.e., w=4 for equal weight). Equal weight implies the default value for the BCW index.

### Bi-Directional Optical Flow (BDOF)

The bi-directional optical flow (BDOF) tool is included in VVC. BDOF, previously referred to as BIO, was included in the JEM. Compared to the JEM version, the BDOF in VVC is a simpler version that requires much less computations, especially in terms of number of multiplications and the size of the multiplier.

BDOF is used to refine the bi-prediction signal of a CU at the 4×4 subblock level. BDOF is applied to a CU if it satisfies all the following conditions:
The CU is coded using “true” bi-prediction mode, i.e., one of the two reference pictures is prior to the current picture in display order and the other is after the current picture in display order.
The distances (i.e. POC difference) from two reference pictures to the current picture are same.
Both reference pictures are short-term reference pictures.
The CU is not coded using affine mode or the SbTMVP merge mode.
CU has more than 64 luma samples.
Both CU height and CU width are larger than or equal to 8 luma samples
BCW weight index indicates equal weight.
WP is not enabled for the current CU.

### CIIP mode is not used for the current CU.

BDOF is only applied to the luma component. As its name indicates, the BDOF mode is based on the optical flow concept, which assumes that the motion of an object is smooth. For each 4 ×4 subblock, a motion refinement (vₓ, v_{y}) is calculated by minimizing the difference between the L0 and L1 prediction samples. The motion refinement is then used to adjust the bi-predicted sample values in the 4×4 subblock.

### Decoder Side Motion Vector Refinement (DMVR) in VVC

In order to increase the accuracy of the MVs of the merge mode, a bilateral-matching (BM) based decoder side motion vector refinement is applied in VVC. In bi-prediction operation, a refined MV is searched around the initial MVs (232 and 234) in the reference picture list L0 22 and reference picture list L1 214 for a current block 220 the current picture 210. The collocated blocks 222 and 224 in L0 and L1 are determined according to the initial MVs 232 and 234) and the location of the current block 220 in the current picture as shown in FIG. 2. The BM method calculates the distortion between the two candidate blocks (242 and 244) in the reference picture list L0 and list L1. The locations of the two candidate blocks (242 and 244) are determined by adding two opposite offset (262 and 264) to the two initial MVs (232 and 234) to derive the two candidate MVs (252 and 254). As illustrated in FIG. 2, the SAD between the candidate blocks (242 and 244) based on each MV candidate around the initial MV (232 or 234) is calculated. The MV candidate (252 or 254) with the lowest SAD becomes the refined MV and used to generate the bi-predicted signal.

In VVC, the application of DMVR is restricted and is only applied for the CUs which are coded with following modes and features:
CU level merge mode with bi-prediction MV
One reference picture is in the past and another reference picture is in the future with respect to the current picture
The distances (i.e. POC difference) from two reference pictures to the current picture are same
Both reference pictures are short-term reference pictures
CU has more than 64 luma samples
Both CU height and CU width are larger than or equal to 8 luma samples
BCW weight index indicates equal weight
WP is not enabled for the current block
CIIP mode is not used for the current block

The refined MV derived by the DMVR process is used to generate the inter prediction samples and also used in temporal motion vector prediction for future pictures coding. While the original MV is used in the deblocking process and also used in spatial motion vector prediction for future CU coding.

### AMVP-Merge Mode

In JVET-X0083 (Zhi Zhang, et. al., “EE2: Bilateral and template matching AMVP-merge mode (test 3.3)”, Joint Video Experts Team (JVET) of ITU-T SG 16 WP 3 and ISO/IEC JTC 1/SC 29, 24th Meeting, by teleconference, 6-15 Oct. 2021, Document: JVET-X0083), AMVP-Merge mode is proposed. In the proposed AMVP-merge mode, the bi-directional predictor is composed of an AMVP predictor in one direction and a merge predictor in the other direction.

AMVP part according to JVET-X0083 is signalled as a regular uni-directional AMVP (i.e. reference index and MVD being signalled) and it has a derived MVP index if template matching is used (e.g. TM_AMVP asserted) or an MVP index is signalled when template matching is disabled. Merge index is not signalled, and merge predictor is selected from the candidate list with the smallest template or bilateral matching cost.

When the selected merge predictor and the AMVP predictor satisfy DMVR condition, which means there is at least one reference picture from the past and one reference picture from the future relatively to the current picture and the distances from two reference pictures to the current picture are the same, the bilateral matching MV refinement is applied to the merge MV candidate and AMVP MVP as a starting point. Otherwise, if template matching functionality is enabled, template matching MV refinement is applied to the merge predictor or the AMVP predictor which has a higher template matching cost.

For the multi-pass DMVR, the third pass, which is 8×8 sub-PU BDOF refinement, is enabled for the AMVP-merge mode coded block.

While the AMVP-merge mode has shown to improve the coding performance, this motion compensation mode is rather computationally intensive. In addition, the bilateral matching algorithm for MV refinement increases the system bandwidth noticeably since the algorithm will have to access bi-directional reference data. Accordingly, schemes to reduce the system bandwidth requirement and/or to further improve the performance are disclosed.

### BRIEF SUMMARY OF THE INVENTION

Methods and apparatus of video coding using a simplified AMVP-merge mode are disclosed. According to this method, input data associated with a current block in a current picture are received, wherein the input data comprise pixel data for the current block to be encoded at an encoder side or coded data associated with the current block to be decoded at a decoder side. A target AMVP (Advance Motion Vector Prediction) candidate is determined from an AMVP candidate list. A merge candidate list is determined. Merge candidates in the merge candidate list are reordered according to MV costs associated with the merge candidates to form a reordered merge candidate list, wherein each MV cost is measured based on one or more factors comprising an MV distance and the MV distance is measured between each candidate in the merge candidate list and a corresponding mapped MV, and wherein said each candidate associated with a first reference picture on one side of the current picture is mapped to the corresponding mapped MV in a second reference picture on another side of the current picture. A target merge candidate is determined from the reordered merge candidate list. A target AMVP-merge candidate is generated based on the target AMVP candidate and the target merge candidate. The current block is encoded or decoded using a motion candidate list comprising the target AMVP-merge candidate.

In one embodiment, one or more merge candidates associated with lower MV costs are moved forward in the reordered merge candidate list. In one embodiment, the merge candidates associated with lower MV costs are assigned smaller merge indexes. In one embodiment, said one or more factors comprise reference indexes and/or POCs (Picture Order Counts) associated with the first reference picture and the second reference picture. In one embodiment, each MV cost is derived as a weighted sum of at least two factors from said one or more factors.

According to another method, a target AMVP candidate is determined from an AMVP candidate list. A target merge candidate is determined from a merge candidate list. A target weighting pair is determined from a weighting pair set comprising two or more weighting pairs. A target AMVP-merge candidate is generated as a weighted sum of the target AMVP candidate and the target merge candidate according to the target weighting pair.

In one embodiment, a weighting index associated with the target weighting pair is inherited from the target merge candidate. In one embodiment, a weighting index associated with the target weighting pair is derived based on a template matching cost and the template matching cost is calculated based on a first neighbouring template for one AMVP reference block and a second neighbouring template for one merge reference block. In one embodiment, a weighting index associated with the target weighting pair is derived based on QP (Quantization parameter) of the current block, POC (Picture Order Count) difference between an AMVP reference picture and a merge reference picture, reference picture ID associated with the AMVP reference picture and the merge reference picture, or a combination thereof.

In one embodiment, a weighting index associated with the target weighting pair is signalled in a bitstream or parsed from the bitstream.

According to another method, input data associated with a current block in a current picture are received, wherein the input data comprise pixel data for the current block to be encoded at an encoder side or coded data associated with the current block to be decoded at a decoder side. A target AMVP (Advance Motion Vector Prediction) candidate is determined from an AMVP candidate list, wherein the AMVP candidate list comprises an affine motion candidate. A target merge candidate is determined from a merge candidate. A target AMVP-merge candidate is generated for a bi-prediction candidate by using the target AMVP candidate in one direction and the target merge candidate in another direction. The current block is encoded or decoded using a motion candidate list comprising the target AMVP-merge candidate.

In one embodiment, the merge candidate list also comprises the affine motion candidate.

In one embodiment, the affine motion candidate is allowed to be included in the AMVP candidate list only when the current block is larger than or smaller than a threshold. For example, the threshold corresponds to a 32×32 block size. In one embodiment, when the affine motion candidate is allowed to be included in the AMVP candidate list, both the AMVP candidate list and the merge candidate list have a same motion type. For example, the same motion type corresponds to translational motion or subblock-based motion.

### BRIEF DESCRIPTION OF THE DRAWINGS

FIG. 1A illustrates an exemplary adaptive Inter/Intra video coding system incorporating loop processing.

FIG. 1B illustrates a corresponding decoder for the encoder in FIG. 1A.

FIG. 2 illustrates an example of Decoder Side Motion Vector Refinement (DMVR) in VVC.

FIG. 3 illustrates an exemplary flowchart for a video coding system using a simplified AMVP-merge mode according to an embodiment of the present invention.

FIG. 4 illustrates an exemplary flowchart for a video coding system using an AMVP-merge mode with Bi-prediction with CU-level Weight (BCW) according to an embodiment of the present invention.

FIG. 5 illustrate an exemplary flowchart for a video coding system using an AMVP-merge mode with Affine motion.

### DETAILED DESCRIPTION OF THE INVENTION

It will be readily understood that the components of the present invention, as generally described and illustrated in the figures herein, may be arranged and designed in a wide variety of different configurations. Thus, the following more detailed description of the embodiments of the systems and methods of the present invention, as represented in the figures, is not intended to limit the scope of the invention, as claimed, but is merely representative of selected embodiments of the invention. References throughout this specification to “one embodiment,” “an embodiment,” or similar language mean that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention. The illustrated embodiments of the invention will be best understood by reference to the drawings, wherein like parts are designated by like numerals throughout. The following description is intended only by way of example, and simply illustrates certain selected embodiments of apparatus and methods that are consistent with the invention as claimed herein.

As mentioned earlier, the AMVP-merge mode is rather computational intensive and the bilateral matching algorithm for MV refinement increases the system bandwidth significantly. Accordingly, schemes to reduce the system bandwidth requirement and/or to further improve the performance are disclosed.

### Method 1: Simplifying Reordering Scheme of Merge Candidate List in AMVP-Merge Mode

In JVET-X0083, merge candidates for AMVP-merge mode will be reordered by bilateral matching first and then one of the top two candidates after reordering will be selected as the final candidate for AMVP-merge mode. One EP (equal probability) bin is signalled to indicate which candidate is selected. Since bilateral matching reordering of merge candidate list in AMVP-Merge process may require higher bandwidth, it is proposed to replace this step by other methods.

In one embodiment, it is proposed to use MV costs to reorder the merge candidate list. The motions with lower MV costs will be moved forward and indicated by a smaller merge index, where the motion refers to motion information associated with a candidate such as motion vector and corresponding reference picture list and reference picture index. For example, MV (i.e. MvL0 or MvL1) in one side will be mapped to the reference picture of the other side (i.e. L1 or L0) based on POC (Picture Order Count). In other words, the mapping is performed with respect to the current picture so that the MV and the mapped MV are on opposite sides of the current picture. After that, the absolute distance between two motions will be used as the MV cost. The closer the two motions are, the smaller the MV cost is. Alternatively, the farther the two motions are, the smaller the MV cost is. For another example, not only the distance between two motions is used as the MV cost, the reference picture indexes of two reference pictures or the POC distance between the current picture and respective reference pictures can also be considered. For another example, the reference picture indexes or POC distances of two reference pictures are used for decision if the distances between two motions of two candidates are the same. For another example, more than one criterion can be used for reordering and the final MV cost is calculated by a weighted sum of multiple factors. (i.e. distance between two motions, reference picture index, or POC of the reference pictures). For another example, more than one criterion can be used for reordering and they are compared by hierarchical algorithm. For example, two motion distances are compared first and only if the two motion distances are the same, the reference picture index are compared.

### Method 2: Enabling AMVP-Merge With BCW

In the original AMVP-merge mode as disclosed in JVET-X0083, the AMVP prediction and merge prediction are combined using a default equal weight. In one embodiment of the present invention, it is proposed to support BCW with AMVP-merge mode. The BCW index can be inherited from the merge candidate. In another embodiment, the BCW index is designed based on TM (Template Matching) cost. For example, neighbouring templates of reference blocks in L0 and L1 of AMVP-merge mode are used to calculate the TM cost. The neighbouring templates can be N above lines and M left lines, where N and M can be any integer larger than 0. For the side with a larger TM cost (either L0 or L1), a smaller weight is used in bi-prediction blending. For another side with smaller TM cost (either L0 or L1), a larger weight is used in bi-prediction blending. For another example, TM refinement or other motion refinement process is applied for AMVP-merge mode. After the final refined motions are derived, more than one BCW index with a different weighting pair is tested on the refined motions. The weighting pair with the lowest TM cost is selected as the final weighting pair. For another example, the BCW index selection can be included with TM refinement process or other motion refinement process. Accordingly, during motion refinement, BCW indexes with different weighting pairs are tested with different motion offsets. For example, each offset in a diamond search is tested with different weighting pairs. By doing this, the optimal BCW index and offset pair can be selected. In another embodiment, a BCW index is directly signalled to the decoder to indicate the weighting pair of AMVP-merge mode as the regular inter mode. In another embodiment, a BCW index is signalled to the decoder to indicate the weighting pair of AMVP-merge mode when the current CU size is smaller than or larger than a pre-defined threshold.

In another embodiment, a BCW index is directly signalled to the decoder to indicate the weighting pair of AMVP-merge mode as the regular inter mode. The smaller weight of the weighting pair of the corresponding BCW index is used for the AMVP predictor and the larger weight of the weighting pair of the corresponding BCW index is used for the merge predictor. Alternatively, it can be designed in an opposite manner, i.e., the larger weight of the weighting pair of the corresponding BCW index is used for merge predictor.

In one embodiment, the BCW index is derived based on QP of the current block, POC difference between an AMVP reference picture and a merge reference picture, reference picture index associated with the AMVP reference picture and the merge reference picture, or any combination of them.

### Method 3: Enabling AMVP-Merge With Affine

In the original AMVP-merge mode as disclosed in JVET-X0083, the affine mode is disabled if AMVP-merge is used. In one embodiment, not only translational motion can be used to predict the AMVP part of AMVP-merge mode, affine motions can also be used to predict the AMVP part of AMVP-merge mode. In another embodiment, the CU size constraints are applied for deciding whether to support the affine mode for AMVP-merge. For example, affine for AMVP-merge mode can only be enabled if the CU size is larger than or smaller than a threshold (e.g. 32×32). In another embodiment, not only translational motion can be used to predict the merge part of AMVP-merge mode, subblock-based merge candidates (i.e. affine motions) can also be used to predict the merge part of AMVP-merge mode. In another embodiment, it can be further constrained that motion type for AMVP part and merge part of AMVP-merge mode shall be the same. For example, if AMVP-merge mode with affine motion candidate is enabled, then motions in both AMVP and merge part are translational motion. For another example, if AMVP-merge mode with affine motion candidate is enabled, then motions in both AMVP and merge part are subblock-based motion.

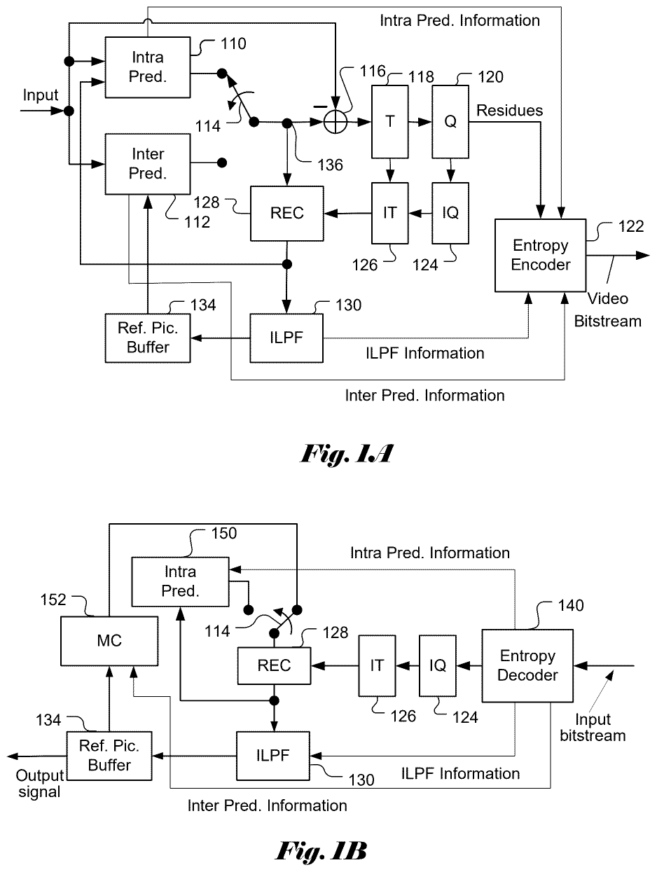

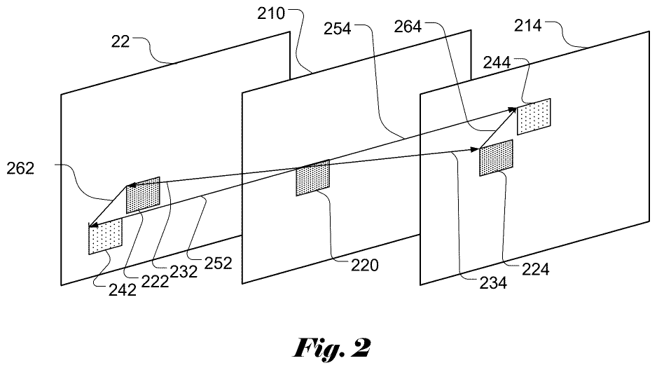

Any of the foregoing proposed AMVP-merge methods can be implemented in encoders and/or decoders. For example, any of the proposed methods can be implemented in inter coding (e.g. Inter Pred. 112 in FIG. 1A) of an encoder, and/or inter coding module (e.g. MC 152 in FIG. 1B) of a decoder. Alternatively, any of the proposed methods can be implemented as a circuit coupled to the inter coding of the encoder and/or the decoder, so as to provide the information needed by the inter coding.

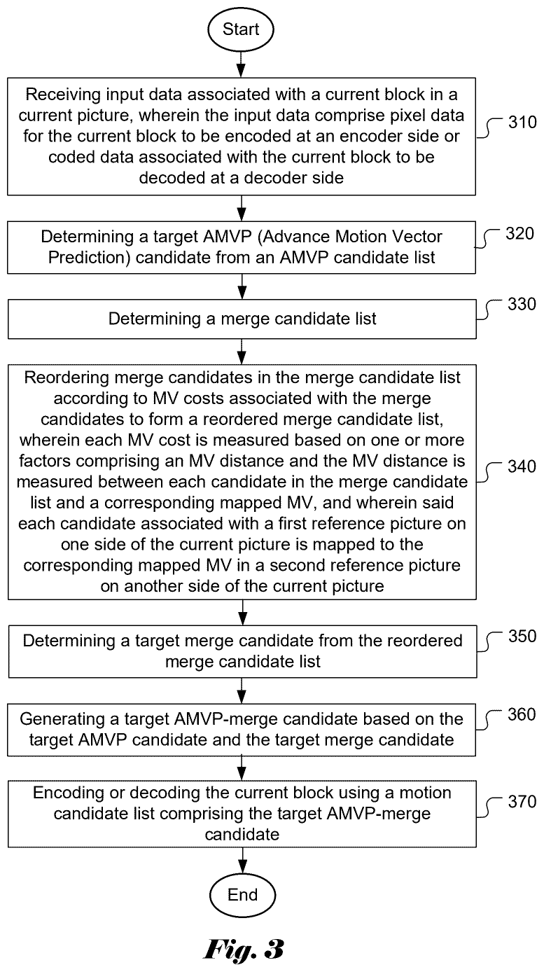

FIG. 3 illustrates an exemplary flowchart for a video coding system using a simplified AMVP-merge mode according to an embodiment of the present invention. The steps shown in the flowchart may be implemented as program codes executable on one or more processors (e.g., one or more CPUs) at the encoder side. The steps shown in the flowchart may also be implemented based hardware such as one or more electronic devices or processors arranged to perform the steps in the flowchart. According to this method, input data associated with a current block in a current picture are received in step 310, wherein the input data comprise pixel data for the current block to be encoded at an encoder side or coded data associated with the current block to be decoded at a decoder side. A target AMVP (Advance Motion Vector Prediction) candidate is determined from an AMVP candidate list in step 320. A merge candidate list is determined in step 330. Merge candidates in the merge candidate list are reordered according to MV costs associated with the merge candidates to form a reordered merge candidate list in step 340, wherein each MV cost is measured based on one or more factors comprising an MV distance and the MV distance is measured between each candidate in the merge candidate list and a corresponding mapped MV, and wherein said each candidate associated with a first reference picture on one side of the current picture is mapped to the corresponding mapped MV in a second reference picture on another side of the current picture. A target merge candidate is determined from the reordered merge candidate list in step 350. A target AMVP-merge candidate is generated based on the target AMVP candidate and the target merge candidate in step 360. The current block is encoded or decoded using a motion candidate list comprising the target AMVP-merge candidate in step 370.

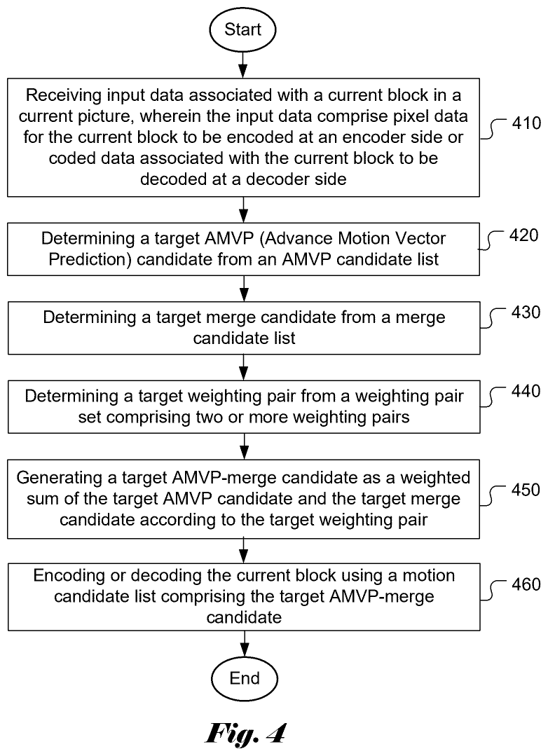

FIG. 4 illustrates an exemplary flowchart for a video coding system using an AMVP-merge mode with Bi-prediction with CU-level Weight (BCW) according to an embodiment of the present invention. According to this method, input data associated with a current block in a current picture are received in step 410, wherein the input data comprise pixel data for the current block to be encoded at an encoder side or coded data associated with the current block to be decoded at a decoder side. A target AMVP (Advance Motion Vector Prediction) candidate is determined from an AMVP candidate list in step 420. A target merge candidate is determined from a merge candidate list in step 430. A target weighting pair is determined from a weighting pair set comprising two or more weighting pairs in step 440. A target AMVP-merge candidate is generated as a weighted sum of the target AMVP candidate and the target merge candidate according to the target weighting pair in step 450. The current block is encoded or decoded using a motion candidate list comprising the target AMVP-merge candidate in step 460.

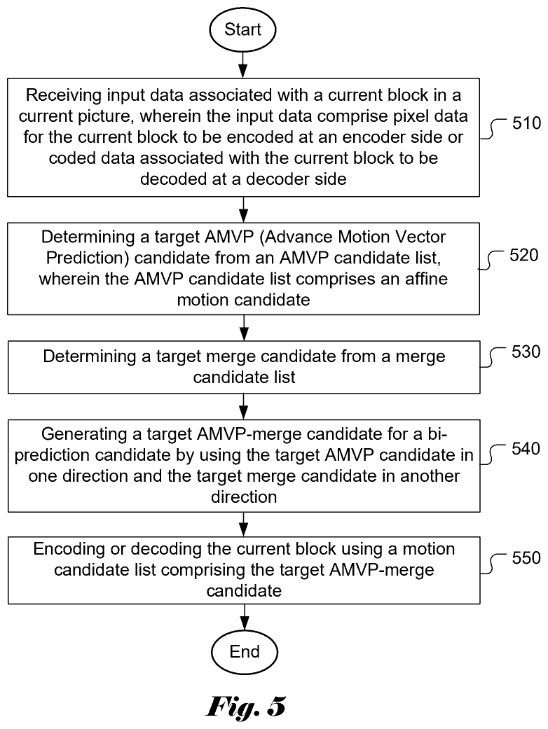

FIG. 5 illustrate an exemplary flowchart for a video coding system using an AMVP-merge mode with Affine motion. According to this method, input data associated with a current block in a current picture are received in step 510, wherein the input data comprise pixel data for the current block to be encoded at an encoder side or coded data associated with the current block to be decoded at a decoder side. A target AMVP (Advance Motion Vector Prediction) candidate is determined from an AMVP candidate list in step 520, wherein the AMVP candidate list comprises an affine motion candidate. A target merge candidate is determined from a merge candidate list in step 530. A target AMVP-merge candidate is generated for a bi-prediction candidate by using the target AMVP candidate in one direction and the target merge candidate in another direction in step 540. The current block is encoded or decoded using a motion candidate list comprising the target AMVP-merge candidate in step 550.

The flowcharts shown are intended to illustrate an example of video coding according to the present invention. A person skilled in the art may modify each step, re-arranges the steps, split a step, or combine steps to practice the present invention without departing from the spirit of the present invention. In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be a circuit integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of video coding, the method comprising:
receiving input data associated with a current block in a current picture, wherein the input data comprise pixel data for the current block to be encoded at an encoder side or coded data associated with the current block to be decoded at a decoder side;
determining a target AMVP (Advance Motion Vector Prediction) candidate from an AMVP candidate list;
determining a merge candidate list;
reordering merge candidates in the merge candidate list according to MV costs associated with the merge candidates to form a reordered merge candidate list, wherein each MV cost is measured based on one or more factors comprising an MV distance and the MV distance is measured between each candidate in the merge candidate list and a corresponding mapped MV, and wherein said each candidate associated with a first reference picture is mapped to the corresponding mapped MV in a second reference picture;
determining a target merge candidate from the reordered merge candidate list;
generating a target AMVP-merge candidate based on the target AMVP candidate and the target merge candidate; and
encoding or decoding the current block using a motion candidate list comprising the target AMVP-merge candidate.

2. The method of claim 1, wherein one or more merge candidates associated with lower MV costs are moved forward in the reordered merge candidate list.

3. The method of claim 1, wherein the merge candidates associated with lower MV costs are assigned smaller merge indexes.

4. The method of claim 1, wherein said one or more factors comprise reference indexes and/or POCs (Picture Order Counts) associated with the first reference picture and the second reference picture.

5. The method of claim 1, wherein said each MV cost is derived as a weighted sum of at least two factors from said one or more factors.

6. An apparatus for video coding, the apparatus comprising one or more electronic circuits or processors arranged to:
receive input data associated with a current block in a current picture, wherein the input data comprise pixel data for the current block to be encoded at an encoder side or coded data associated with the current block to be decoded at a decoder side;
determine a target AMVP (Advance Motion Vector Prediction) candidate from an AMVP candidate list;
determine a merge candidate list;
reorder merge candidates in the merge candidate list according to MV costs associated with the merge candidates to form a reordered merge candidate list, wherein each MV cost is measured based on one or more factors comprising an MV distance and the MV distance is measured between each candidate in the merge candidate list and a corresponding mapped MV, and wherein said each candidate associated with a first reference picture is mapped to the corresponding mapped MV in a second reference picture;
determine a target merge candidate from the reordered merge candidate list;
generate a target AMVP-merge candidate based on the target AMVP candidate and the target merge candidate; and
encode or decode the current block using a motion candidate list comprising the target AMVP-merge candidate.

7. A method of video coding, the method comprising:
receiving input data associated with a current block in a current picture, wherein the input data comprise pixel data for the current block to be encoded at an encoder side or coded data associated with the current block to be decoded at a decoder side;
determining a target AMVP (Advance Motion Vector Prediction) candidate from an AMVP candidate list;
determining a target merge candidate from a merge candidate list;
determining a target weighting pair from a weighting pair set comprising two or more weighting pairs;
generating a target AMVP-merge candidate as a weighted sum of the target AMVP candidate and the target merge candidate according to the target weighting pair; and
encoding or decoding the current block using a motion candidate list comprising the target AMVP-merge candidate.

8. The method of claim 7, wherein a weighting index associated with the target weighting pair is inherited from the target merge candidate.

9. The method of claim 7, wherein a weighting index associated with the target weighting pair is derived based on a template matching cost and the template matching cost is calculated based on a first neighbouring template for one AMVP reference block and a second neighbouring template for one merge reference block.

10. The method of claim 7, wherein a weighting index associated with the target weighting pair is derived based on slice QPs (Quantization parameters) of one AMVP reference picture and one merge reference picture, POC (Picture Order Count) difference between said one AMVP reference picture and the current picture, and the POC between said one merge reference picture and the current picture, reference picture ID associated with the AMVP reference picture and the merge reference picture, or a combination thereof.

11. The method of claim 7, wherein a weighting index associated with the target weighting pair is signalled in a bitstream or parsed from the bitstream.

12. An apparatus for video coding, the apparatus comprising one or more electronic circuits or processors arranged to:
receive input data associated with a current block in a current picture, wherein the input data comprise pixel data for the current block to be encoded at an encoder side or coded data associated with the current block to be decoded at a decoder side;
determine a target AMVP (Advance Motion Vector Prediction) candidate from an AMVP candidate list;
determine a target merge candidate from a merge candidate list;
determine a target weighting pair from a weighting pair set comprising two or more weighting pairs;
generate a target AMVP-merge candidate as a weighted sum of the target AMVP candidate and the target merge candidate according to the target weighting pair; and
encode or decode the current block using a motion candidate list comprising the target AMVP-merge candidate.

13. A method of video coding, the method comprising:
receiving input data associated with a current block in a current picture, wherein the input data comprise pixel data for the current block to be encoded at an encoder side or coded data associated with the current block to be decoded at a decoder side;
determining a target AMVP (Advance Motion Vector Prediction) candidate from an AMVP candidate list, wherein the AMVP candidate list comprises an affine motion candidate;
determining a target merge candidate from a merge candidate list;
generating a target AMVP-merge candidate for a bi-prediction candidate by using the target AMVP candidate in one direction and the target merge candidate in another direction; and
encoding or decoding the current block using a motion candidate list comprising the target AMVP-merge candidate.

14. The method of claim 13, wherein the merge candidate list also comprises the affine motion candidate.

15. The method of claim 14, wherein the affine motion candidate is allowed to be included in the AMVP candidate list only when the current block is larger than or smaller than a threshold.

16. The method of claim 15, wherein the threshold corresponds to a 32×32 block size.

17. The method of claim 13, wherein when the affine motion candidate is allowed to be included in the AMVP candidate list, both the AMVP candidate list and the merge candidate list have a same motion type.

18. The method of claim 17, wherein the same motion type corresponds to translational motion or subblock-based motion.

19. An apparatus for video coding, the apparatus comprising one or more electronic circuits or processors arranged to:
receive input data associated with a current block in a current picture, wherein the input data comprise pixel data for the current block to be encoded at an encoder side or coded data associated with the current block to be decoded at a decoder side;
determine a target AMVP (Advance Motion Vector Prediction) candidate from an AMVP candidate list, wherein the AMVP candidate list comprises an affine motion candidate;
determine a target merge candidate from a merge candidate list;
generating a target AMVP-merge candidate for a bi-prediction candidate by using the target AMVP candidate in one direction and the target merge candidate in another direction; and
encode or decode the current block using a motion candidate list comprising the target AMVP-merge candidate.
